(19) United States
(12) Patent Application Publication
(10) Pub. No.: US 2017/0092968 A1
(43) Pub. Date: Mar. 30, 2017

(54) Device and Method for Extending the Service Life of HT-PEM Fuel Cells

(71) Applicant: Siqens GmbH, München (DE)

(72) Inventors: Volker Harbusch, München (DE); Felix Hennersperger, Olching (DE)

(21) Appl. No.: 15/126,494

(22) PCT Filed: Mar. 27, 2015
(86) PCT No.: PCT/EP2015/056793

§ 371 Date: Sep. 15, 2016

(30) Foreign Application Priority Data
Mar. 27, 2014 (DE) 10 2014 104 310.3

(51) Int. Cl. H01M 8/04276; H01M 8/1007; H01M 8/103; H01M 8/24; H01M 8/0263; H01M 8/241; H01M 8/2457; H01M 8/1004; H01M 8/1025

(52) U.S. Cl. CPC H01M 8/04283; H01M 8/1004; H01M 8/1007; H01M 8/103; H01M 8/1025; H01M 8/0263; H01M 8/241; H01M 8/2457; H01M 8/2459; H01M 2008/1095

(57) ABSTRACT

According to the invention, a device is provided for extending the service life of a high-temperature polymer electrolyte membrane fuel cell. This device includes an HT-PEM fuel cell with at least one cell. The cell is constructed according to the following sequence: a supply plate with an anode channel structure, an anode gas diffusion electrode, an electrolyte-containing polymer membrane, a cathode gas diffusion electrode, and a supply plate with a cathode channel structure. In addition, at least one acid-filled acid reservoir is provided, which is connected to a distributor channel extending in the supply plates approximately perpendicular to the channel structures, the distributor channel being connected to at least one of the gas diffusion electrodes and/or the polymer membrane of at least one of the cells of the fuel cell stack in such a way that acid can be supplied to at least one of the gas diffusion electrodes and/or the polymer membrane of at least one of the cells of the fuel cell stack.

The present invention relates to a device and method for extending the service life of high-temperature polymer electrolyte membrane fuel cells (HT-PEM FC).

With the start of the use of polymer membranes as invariant solid electrolytes (PEM fuel cells) in fuel cell technology, attention has turned to proton-conducting membranes among other things based on base polymers such as polybenzimidazole.

In the latter, the proton-conducting polymer is doped with an electrolyte, in particular a powerful acid such as sulfuric acid or phosphoric acid. This doping yields a polymer electrolyte that constitutes a single-phase system in which the acid is complexed by means of the polymer.

A high-temperature polymer electrolyte membrane (HT-PEM)—a membrane electrode assembly (MEA) or an individual cell—includes two electrodes between which is situated a polymer membrane.

For example, the polymer membrane is a polybenzimidazole—(PBI) or polyether membrane, which has a polymer support matrix. Liquid phosphoric acid is stored as an electrolyte in the polymer support matrix.

The electrodes and gas diffusion electrodes include a gas-permeable and electrically conductive gas diffusion substrate onto which a catalyst, usually platinum, is deposited. As a substrate, the catalyst usually uses carbon particles such as soot or an inorganic substance with electrical conductivity such as carbide. An electrode layer of this kind usually also has additives such as polytetrafluoroethylene (PTFE) or PBI for stabilization and for achieving a good ionic conductivity. In addition, this construction permits a good supply with reactands.

Between the gas diffusion substrate and the electrode layer, an additional layer (microporous layer) can be provided, which is composed of soot and if need be, additives such as PTFE. This serves as a substrate layer for the catalyst layer. With a suitable embodiment such as a high degree of hydrophobicity due to a high percentage of PTFE, this reduces the entry of liquid electrolyte from the electrode layer into the gas diffusion substrate during operation of the fuel cell.

As electrodes of a fuel cell, an anode gas diffusion electrode (anode GDE) and a cathode gas diffusion electrode (cathode GDE) are provided.

An electrode includes the gas diffusion substrate, the catalyst layer, and optionally also an intermediate layer that is situated beneath the catalyst layer.

Both the anode GDE and the cathode GDE contain acid in order to produce an ionic contact between the electrolyte system (e.g. PBI membrane with absorbed phosphoric acid) and the catalyst.

To supply the MEAs, supply plates are provided, which have an anode channel structure and a cathode channel structure. The supply plates are plates composed of an electrically conductive material such as graphite-containing or metallic materials in which the channel structure is provided. If both an anode channel structure and a cathode channel structure are provided in a plate, then this plate is referred to as a bipolar plate. The media are sealed by means of sealing frames, for example composed of FKM (fluorinated rubber), PFA (perfluoroalkoxy alkane), or PTFE (polytetrafluoroethylene).

In a fuel cell stack, a plurality of plates connected one after another have one or more channels for supplying the anode and one or more channels for supplying the cathode.

In addition, phosphoric acid fuel cells (PAFC) are known from the prior art. In these fuel cells, the catalyst, usually platinum, is deposited onto carbon particles, which are generally held together with the aid of polytetrafluoroethylene (PTFE). Phosphoric acid is stored in this cohesive, porous electrode structure. The phosphoric acid is in a liquid state and is highly concentrated. As an electrolyte system, a matrix is used in which liquid or gelatinous phosphoric acid is stored in silicon carbide. At operating temperatures of approx. 200° C., the phosphoric acid gradually boils away, which results in the fact that a part of the phosphoric acid evaporates via the cathode channel structure over the service life. In order to replenish the supply of phosphoric acid, the channel structures are frequently formed in plates made of porous graphite, with phosphoric acid being stored in the interstices that are present due to the porosity. This phosphoric acid travels to the electrodes and to the electrolyte system based on the capillary effect. A capillary effect is present because the pores of the electrolyte matrix are smaller in size than the pores of the supply plates. In order to prevent leakiness of the electrode chambers, subregions of the bipolar plates are embodied as non-porous or plate attachments are used, which have gas-impermeable plates between the porous plates.

U.S. Pat. No. 7,763,390 B2 describes devices intended to extend the service life of a phosphoric acid fuel cell. In these devices, between a catalyst layer and a channel structure, a hydrophilic layer is provided in which the phosphoric acid is stored.

JP 10 320 10 and JP 11 016 589 have disclosed phosphoric acid fuel cells that use reservoir plates. The pores of the reservoir plates have a larger diameter than the pores of the catalyst layer. In this case, phosphoric acid is stored in the corresponding reservoirs and/or pores of the electrolyte reservoir plates.

This excess of phosphoric acid should compensate for the loss of phosphoric acid due to evaporation or absorption by cell components. In particular, the reservoir plates have channels that contain a filler that is saturated with phosphoric acid.

The transport of the phosphoric acid should take place by means of the capillary effect. For example, the phosphoric acid is absorbed in a porous carbon by a porous carbon fleece and is placed between the electrodes.

According to JP 09 035 727 and JP 02 204 973, an external phosphoric acid tank is used and by means of this, the phosphoric acid is supplied to the filler or the carbon fleece in the reservoir plates.

JP 02 299 165 describes a system in which the phosphoric acid is to be heated in a phosphoric acid tank in order to produce phosphoric acid vapor, which is then supplied to the fuel cell in gaseous form.

In phosphoric acid fuel cells, the porous graphite plates make it possible to replenish the phosphoric acid quickly and easily. Such systems, however, have the disadvantage of a high phosphoric acid concentration in the electrodes, which inhibits the supply of reactands, particularly the supply of oxygen, to the catalyst. In addition, a phosphate adsorption at the catalyst (platinum) causes a catalytic inhibition. This negative impact on the kinetics manifests itself in low fuel cell voltages and/or low power densities.

In a high-temperature polymer electrolyte membrane fuel cell, the acid, usually phosphoric acid, is bonded better than in a phosphoric acid fuel cell since it is stored in liquid form in the PBI matrix and is directly or indirectly bonded ionically. In addition, the acid concentration in the electrodes is lower. As a result, the acid loss during operation is lower in high-temperature polymer electrolyte fuel cells than in phosphoric acid fuel cells.

Nevertheless, even with high-temperature polymer electrolyte membrane fuel cells, particularly in certain operating states and operating modes, acid loss occurs during operation. This is due to the fact that during operation at an operating temperature of 140° C. to 210° C., in which the fuel cell is supplied with air and hydrogen, the acid in the membrane electrode assembly (MEA) is continuously discharged from the MEA over the service life. The discharging particularly takes place via the cathode exhaust gas, but also via the anode exhaust gas. When discharged, the acid is released from the MEA by means of evaporation. This process is particularly promoted at high operating temperatures and high cathode supply lambdas, particularly at an air lambda>2.

Furthermore, the acid can also form esters with unconverted and/or unreformed fuel such as trimethyl ester, which then emerges as a gaseous substance. Consequently, the membrane and the electrodes continuously lose acid over their lifetimes, which leads to a reduction in the ionic conductivity of the MEA. This acid loss continues until the membrane, for lack of acid, can no longer function as a fuel cell electrolyte since an excessively high ionic resistance is present. This sharply reduces the service life.

DE 199 14 247 A1 discloses an HTM fuel cell with a reduced electrolyte flushing, an HTM fuel cell battery, and a method for starting an HTM fuel cell and/or an HTM fuel cell battery. The basic principle of this device lies in capturing the electrolyte that has been flushed from the fuel cell and conveying it back into the fuel cell. The device has a reservoir in which the electrolyte that has been flushed from the cell which can be temporarily stored. In this case, the electrolyte support, e.g. a porous matrix, or a membrane protrudes directly into the reservoir with an edge region or else capillaries and/or channels are integrated into the electrolyte support to make it possible to return the electrolyte. Alternatively, an additional line can be provided, which connects the reservoir to the membrane directly in such a way that the flushed electrolyte can be captured and automatically conveyed back into the cell after an equilibrium is established. Particularly during the starting procedure of the system in which the fuel cell stack has not yet reached its operating temperature, it should thus be possible to reduce the electrolyte loss that occurs.

DE 11 2010 002 798 T5 has disclosed a method for reducing the loss of liquid electrolyte from a high-temperature polymer electrolyte membrane fuel cell. In this case, a fuel flow and/or air flow is enriched with vapor of the liquid electrolyte; the liquid electrolyte can be replenished by means of an electrochemical reaction. The method also includes the supply of the liquid electrolyte vapor to the polymer electrolyte membrane-containing fuel cell by means of one or more gas-permeable anodes and gas-permeable cathodes. This should reduce a loss of liquid electrolyte from the membrane of the fuel cell, which extends the service life of the fuel cell.

The object of the present invention, therefore, is to create a device and a method that are able to extend the service life of high-temperature polymer electrolyte membrane fuel cells.

This object is attained with a device according to claim 1 and a method according to claim 13. Advantageous embodiments are disclosed by their respective dependent claims.

According to the invention, a device is provided for extending the service life of a high-temperature polymer electrolyte membrane fuel cell. This device includes an HT-PEM fuel cell stack in which each cell includes a supply plate with an anode channel structure, an anode gas diffusion electrode, an electrolyte-containing polymer membrane, a cathode gas diffusion electrode, and a supply plate with a cathode channel structure. In addition, at least one acid-filled acid reservoir is provided that is connected to a distributor channel, which extends in the supply plates approximately perpendicular to the channel structures, the distributor channel being connected to at least one of the gas diffusion electrodes and/or the polymer membrane of at least one of the cells of the fuel cell stack in such a way that acid can be supplied to at least one of the gas diffusion electrodes and/or the polymer membrane of at least one of the cells of the fuel cell stack.

Because a distributor channel is provided that extends in the supply plates approximately perpendicular to the channel structures, it is possible to supply the electrolyte or acid to the cells in a simple way since the acid can be supplied via a connection provided in the vicinity of the first and/or last supply plate. A supply of this kind is referred to as an end-face supply.

If one were to supply the electrolyte via a channel extending parallel to the plane of the channel structures, i.e. a channel that extends from the inside of the fuel cell stack to the outside through lateral edge regions of the fuel cell stack, leakage problems could occur in these regions, negatively influencing the operational reliability. This is due to the fact that fuel cell stacks are embodied as sealed in their lateral edge regions by means of pressing and in particular by means of sealing elements such as sealing frames. A sealing of this kind of a channel that extends out from these edge regions, particularly to each cell, therefore results in numerous construction problems.

Such a channel embodied in the membrane, extending through a lateral edge region of the fuel cell stack, is disclosed in DE 199 14 247 A1. According to the embodiments disclosed therein, either the membrane is squeezed between two supply plates in such a way that an efficient supply of acid is not possible or all of the components of an individual cell must be sealed in the edge region, which is arguably not possible since phosphoric acid and/or reactands would penetrate into unwanted regions in any case.

Preferably, acid is supplied to each cell.

In the context of the present invention, an acid is understood to be an electrolyte that is suitable for HT-PEM fuel cells, in particular phosphoric acid or sulfuric acid.

Preferably, a polybenzimidazole (PBI) membrane can be provided as an electrolyte membrane.

Under laboratory conditions, running times of more than ten thousand hours were achieved in high-temperature polymer electrolyte fuel cells at a temperature of 160° C. and with a supply of pure water. Since prior applications did not have increased demands with regard to the service life, no research efforts were expended on replenishing acid in high-temperature polymer electrolyte membrane fuel cells.

The present invention is based among other things on the realization that the discharge of acid is particularly promoted in start/stop cycles. In mobile applications in which predominantly HT-PEM fuel cells and not phosphoric acid fuel cells are used, frequent start/stop cycles are very important.

The inventors of the present invention have realized that replenishing acid in HT-PEM fuel cells enables a longer service life in both stationary and mobile applications, particularly with frequent start/stop cycles.

In addition, it is possible to simplify the design of a fuel cell system since reformate cleaning stages, which would hold back fuel before it entered the fuel cell in order to inhibit an acid discharge due to reaction of the acid with the fuel, can be eliminated or reduced.

A simple system architecture is also enabled by the fact that providing a replenishing of acid makes it possible to reduce the number of reformer units in the system since a complete reforming is no longer absolutely required.

Contrary to phosphoric acid fuel cells, in HT-PEM fuel cells, it is possible to reduce the acid loading in the electrode layers since the acid is less mobile than in the phosphoric acid fuel cell and since the polymer membrane binds the acid more powerfully than the electrolyte matrix of the phosphoric acid fuel cell. The cause of this is the proteolytic reaction of phosphoric acid with the polymer support matrix, which for example contains basic imidazole groups. A reduced acid loading in the electrode achieves a better supply of material (e.g. air) and a reduced kinetic inhibition of the electrode catalyst. Whereas in HT-PEM fuel cells, the acid, e.g. phosphoric acid, chemically interacts with the polymer in an acid/base reaction, in phosphoric acid fuel cells, the phosphoric acid is only stored physically. Ideally, an optimal acid loading occurs in the electrolyte system of HT-PEM fuel cells; specifically speaking, the electrodes have enough phosphoric acid to achieve a low-resistance ionic bonding of the catalyst to the electrolyte system, but not too much, the goal being to pose the least possible hindrance to a supply of reactands, i.e. atmospheric oxygen or hydrogen.

Based on this characteristic, HT-PEM fuel cells have more powerful kinetics than a phosphoric acid fuel cell. But since a loss of acid due to a shifting of the optimal concentration results in a lack of acid, it diminishes the performance of the fuel cell and the lack of acid replenishment reduces the service life.

Due to the more powerful electrode kinetics of HT-PEM fuel cells in comparison to phosphoric acid fuel cells, the electrode/electrolyte system has an optimal acid quantity. Due to acid discharge, this optimum is abandoned and a degradation occurs, which reduces the service life.

In order to nevertheless ensure a long service life of the HT-PEM fuel cell, an excess of acid is used, usually accompanied by an initially excessive concentration in the electrodes and thicker electrolyte membranes, which cause a high ionic resistance. An alternative for extending the service life is to operate the HT-PEM fuel cell at lower temperatures (e.g. 150° C.) in order to minimize the discharge of acid. At low temperatures, however, the power density of the fuel cell is lower.

In order to achieve a low or optimal acid loading, porous plates or bipolar plates in which the acid is stored cannot be used in HT-PEM fuel cells. Using acid-impregnated plates is also more complex and more expensive in terms of production engineering. Consequently, in HT-PEM fuel cells, it has not been possible up to this point to reuse evaporated acid, which results in a significantly shorter service life as compared to phosphoric acid fuel cells.

PEM fuel cells based on electrolyte membranes of this kind are operated at operating temperatures above the boiling point of water. A proton transport is not bound to the presence of water in the electrolyte system. Under these operating conditions, water occurs in gaseous form.

By contrast with low-temperature PEM fuel cells, a significant disadvantage of fuel cells based on a polymer membrane doped with phosphoric acid, however, lies in the fact that
under operating conditions that result in water in a condensed form, the electrolyte can be diluted and discharged while dissolved in water.
at higher temperatures, the electrolyte is discharged in gaseous form due its vapor pressure.
in the case of fuel cells that are operated with reformate gas, the electrolyte can form compounds with unconverted fuel, such as trimethyl phosphoric acid ester, which can be discharged in gaseous or liquid form.

This effect is also referred to as “leaching.” As a result of this, the ion- or proton conductivity of the membrane and/or electrode decreases over time, which results in an increase in the internal resistance of the cell and thus to a reduction in cell performance.

The present invention is based on the realization that by supplying or replenishing acid, it is possible to avoid significant disadvantages of HT-PEM fuel cells and to retain their advantage in comparison to phosphoric acid fuel cells, which lies in the more favorable acid concentration in the electrode electrolyte chamber.

According to the invention, the fuel cell has an acid-filled acid reservoir, which can have an open passage, particularly to the gas diffusion substrate, via which acid in liquid form passes through the gas diffusion substrate into the electrode (electrode layer) and from there, is supplied to the polymer membrane until the latter once again has a sufficient percentage of acid.

A planar distribution of the acid in this case takes place by means of the electrode layer, the gas diffusion substrate, and the polymer membrane. Particularly in the boundary layer between the electrode layer and the polymer membrane, a distribution of acid takes place where due to the formation of product water, it is greater in the cathode than in the anode. Part of the acid is released by or from the membrane to the electrode opposite the acid supply.

An “open passage” is understood to be any channel-like structure, even if it is embodied as a capillary, a transport aid, or a supply element.

In the context of the present invention, an “acid reservoir” is understood to be a storage tank, chamber, or reservoir filled with acid or also a system integrated into the supply plate with different line sections or channels and in particular also a supply channel or also an acid supply reservoir.

The acid reservoir can be integrated into the supply plate and can be connected to a storage tank via a line section. A supply device such as a pump can be integrated into the line section.

Particularly with a PBI membrane, the supply of acid should be provided into the active region of the membrane, i.e. into the region in which proton conduction takes place (proton conduction takes place between the regions of the electrodes in which the anode- and cathode reaction is taking place) or at least into the edge region thereof since the acid transport is also efficient in the electrodes and particularly in the active region of the membrane electrode system.

As a result, the acid supply takes place via corresponding means that are described in greater detail below at least into an edge region of the active region of the PBI membrane, where the acid for the reaction is required. A squeezing of the membrane significantly reduces the acid transport.

The device can have a control unit, which triggers the supply device in a way that enables a monitored, controlled supply of acid into each cell of a fuel cell stack. The control parameters can be determined based on service life and/or performance characteristic curves.

The integrated distributor system of the device can have a distributor channel, which extends perpendicular to the anode- and cathode channel structure and the supply plates, through all of the cells of a fuel cell stack. Branching off from this distributor channel is a connecting channel, which is embodied in the plane of the channel structures, is situated in the edge region of the supply plate, and is connected to a supply channel that is likewise embodied in the same plane.

The supply channel can be situated in the vicinity of the channel structure, next to it, or surrounding it.

Acid from outside the fuel cell can be supplied to the individual cells of the fuel cell stack via these channels.

With a vertical orientation of the supply plate, since a gravity-induced drainage of the acid from the supply channel—for example through the porous gas diffusion substrate into adjacent underlying feed channels—may not be desired, the supply channel can preferably be situated in the lower part of the supply plate (close to the support surface of the fuel cell stack).

In addition, a reservoir can be integrated into the connecting channel and/or supply channel. The reservoir can be embodied as a recess in the supply plate. This reservoir serves as a buffer and/or dosing aid.

The reservoir can also simply be an expanded section of the connecting channel and/or supply channel. The volume of the reservoir is at least 0.01 ml to 0.5 ml.

According to the invention, it is also possible for the device not to have an external storage tank. Then the acid is only supplied from at least one internal reservoir. If these reservoirs are empty, then as part of an acid service, the reservoirs can be refilled with acid. For example, the individual reservoirs of each supply plate can be connected to one another via a distributor channel so that the reservoirs can be filled with acid from outside via a closable filler neck all at once or one after another. Depending on the size of the cell area, the volume of a corresponding reservoir is at least 0.1 ml to approximately 5 ml and in particular, is at least 0.2 to 2.5 ml. A device of this kind constitutes a separate concept of the invention.

The individual components for the acid supply—including the connecting channel, the reservoir, and the supply channel—can also be embodied in the form of a cavity in the sealing frames of the cell and/or a polymer film (subgasket) that constitutes a reinforcing frame.

According to another embodiment of the device according to the invention it is also possible for the reinforcing frame or polymer membrane, e.g. a PBI membrane, to have a surrounding edge section. In the edge section, two or more polymer films that are stacked on top of each other are provided, which form capillaries in their boundary layers, i.e. the gap and/or space between the films enable(s) the transport of acid through capillary forces. Instead of a polymer film, it is also possible for an edge region of the electrolyte membrane to extend into this region. In this case, the acid can be supplied to the cell via the capillaries, which constitute a supply element as defined by the present invention. One region of the edge section extends into the region of the distributor channel so that acid can be replenished via this region into the polymer membrane and from there, also correspondingly into the anode gas diffusion electrode and/or the cathode gas diffusion electrode.

In order to enable a better or faster distribution of acid directly on the membrane, a transport aid for acid in the form of a wick or a net arranged in planar fashion or suitably oriented fibers can also be positioned between the electrode and the membrane. The fibers are provided in such a way that they convey acid and if possible, absorb enough acid that they do not hinder the proton conduction of the combination of electrolyte membrane and transport aid. In order to minimize the ionic resistance of the transport aid (e.g. fibers), the latter is/are embodied as thin. Instead of fibers or a net, it is also possible to use a thin fleece or another acid-conducting material such as silicon carbide. In order to avoid an excessive release of acid to the cathode, it is advantageous to situate this transport aid on the anode and consequently to supply the cathode electrode via the membrane.

The transport aid can also directly contact the acid via a supply channel.

Also according to this embodiment, the adjacent electrode and membrane are supplied with acid via the supply channel and via the acid reservoir. The membrane in turn releases acid to the opposing electrode layer.

According to another embodiment, a channel structure for circulating acid can also be provided in the fuel cell stack.

The acid replenishment in this case can take place continuously or discontinuously (e.g. in intervals of 500 operating hours). This method has the advantage that it assures that all of the channels are supplied with acid in a bubble-free, i.e. uniform, fashion. This cyclical supply can be supplied with concentrated acid by a metering pump. This is particularly advantageous if the acid, due to its hygroscopic properties, absorbs water from the cell media and the acid concentration of the latter decreases.

According to another embodiment, which constitutes a separate concept of the invention, however, it is also possible to supply the acid via a channel extending parallel to the plane of the channel structures, i.e. via a channel that extends from the inside of the fuel cell stack outward through lateral edge regions of the fuel cell stack.

This embodiment can be embodied in accordance with the embodiments described in the context of the present invention, with the difference being that the supply of acid does not take place based on a distributor channel situated in the supply plates, but rather via an acid reservoir or acid channel that is situated outside the fuel cell stack.

Consequently, a transport aid, a supply element, or at least two layers of a polymer film extend(s) through the lateral edge region in order to supply the cells with acid.

In an embodiment of this kind, it is possible to supply the individual cells with acid separately. Corresponding metering pumps can be provided for this.

According to all of the embodiments, the different hydrophilicity of the components of the membrane electrode assembly, even the gas diffusion substrate, vis-à-vis acid are utilized in order to adjust an optimal acid concentration both in the membrane and in the electrode layers.

A method for extending the service life of high-temperature polymer electrolyte membrane fuel cells is described below.

In a method according to the invention for extending the service life of high-temperature polymer electrolyte membrane fuel cells, at least one cell of a fuel cell is supplied with acid from an acid reservoir.

Preferably, a replenishing supply of acid is provided in all of the cells. In exceptional cases, it is also possible for not all cells to be equipped with a replenishment of acid, for example if an uneven temperature distribution prevails, with some cells having a lower acid loss due to a lower temperature.

The supply can be provided by means of an acid reservoir or via a supply channel with an open passage to the GDE or to the membrane in such a way that the acid travels into the electrode layer and from there, into the polymer membrane or vice versa.

In the method according to the invention for extending the service life of high-temperature polymer electrolyte membrane fuel cells, the supply by means of the acid reservoir can be carried out in such a way that the acid travels via an open passage of the acid reservoir into the gas diffusion substrate, from there into the electrode layer, and from there via diffusion processes into the polymer membrane.

In addition, a part of the acid can be released to the GDE on the opposite side of the membrane.

Since in most membrane electrode assemblies, the gas diffusion substrate and/or the electrode layer—because of its diffusion properties (porosity, wetting)—conducts acid better than the polymer electrolyte, the distribution of acid—i.e. the acid transport—in the cell primarily occurs in the GDEs.

With the conduction of acid in the GDE, a transport takes place in the substrate and in the microporous structure of the electrode layer. Frequently, an additional layer of highly porous carbon is provided beneath the electrode layer.

This transport path is aided by degradation processes (e.g. carbon corrosion) of the electrode layer and gas diffusion substrate, which result in a more hydrophilic character of the carbon surfaces. The product water produced at the cathode and the water-containing media at the anode also foster this diffusion path since this increases the volume of acid in the electrode. Since the electrode layer is wetted with acid, it can have a good wetting capacity despite a possibly high percentage of hydrophobic binders such as PTFE.

According to the invention, surface-active substances (e.g. isopropanol, tensides) can be added to the acid in order to accelerate the passage through the gas diffusion substrate.

In order to foster the transport in the electrode, acid-conducting components (e.g. glass fibers) can also be integrated into the electrode layer. This could be achieved, for example, by inserting or working special fibers (e.g. glass fibers) into the diffusion substrate, which conduct acid well and release it poorly (in small quantities) to the substrate (e.g. hollow fibers) so that the acid transport is essentially enabled via the fibers. The special fibers have a mesh width that is large enough to have hardly any negative impact on the gas transport. A net of such fibers can also be positioned between the flow field and the gas diffusion substrate. Furthermore, layers (e.g. with a lower percentage of PTFE) can also be integrated into the GDE.

The gas diffusion substrate can also have places with highly hydrophilic properties (e.g. a lower percentage of PTFE).

Channels or cuts for supplying acid can also be embodied in the gas diffusion electrode. These can, for example, be punched-out regions, simple cuts, or narrow cavities (<1 mm). A hydrophilization of regions of the gas diffusion electrode to promote the phosphoric acid transport can be achieved by means of plasma treatment or by means of laser-, chemical-, or physical surface treatment. These precautionary measures are particularly provided in the regions of the electrode that are wetted with phosphoric acid.

The use of this diffusion path via the gas diffusion substrate to replenish acid in the fuel cell stack is particularly suitable in HT-PEM fuel cells. In phosphoric acid fuel cells, primarily the path via the porous SiC electrolyte is used for replenishing the phosphoric acid since these fuel cells do not have the problem of membrane swelling that occurs in HT-PEM polymer membranes when direct contact with concentrated phosphoric acid occurs (particularly at high temperatures). Furthermore, in HT-PEM polymer membranes, the acid migration within the polymer matrix in which the acid molecules are complexed only occurs very slowly while the acid transport within the pores of the SiC electrolyte layer of phosphoric acid fuel cells is driven by capillary forces.

According to the method, it is also possible for the acid from an acid reservoir to travel directly into the polymer membrane via at least one section of the polymer membrane that is in contact with the acid from the acid reservoir. In order to prevent a swelling of the polymer membrane, the acid can for example be diluted with a hydrophilic high-boiling liquid such as ethylene glycol.

It is generally useful if the supply of acid into the MEA occurs slowly since otherwise, too much acid penetrates locally into the gas diffusion substrate or into the MEA. Too high a supply speed results in the following:
If too much acid travels into the electrode, this can inhibit the gas supply, in particular the oxygen supply, which causes the electrode kinetics to deteriorate.
If too much acid travels into the electrode, it can come back out of the gas diffusion substrate and flow into the media channels (anode- and cathode channels). This should be avoided since it can clog individual channels or at least reduce their flow cross-sections in an irregular fashion. This results in an uneven distribution of media between the cells.
If in parts of the electrolyte system that is composed for example of PBI and acid, too high an acid concentration occurs because the acid transport within the electrolyte system occurs too slowly, then this can cause a powerful swelling of the electrolyte membrane. As a result, the membrane becomes mechanically unstable and this may possibly result in cracking.

In order to prevent channels of the supply plate from clogging when acid is supplied quickly, the] supply plate, preferably a cathode flow field, can be provided in such a way that its channels have cross-sections that are large enough that a clogging of the channels due to the wetting of the channel walls with a replenishing of acid does not occur or else the cross-sections of the channels can be small enough that in the event of a clogging with acid, the acid is driven out of the channel by the flow of the medium so that the supply of medium in the channel is not interrupted.

In order to prevent the above-mentioned problems, the supply speed can be reduced by means of the following measures:
By means of gravity: if the reservoir is situated beneath or at the same height as the supply channel, the force of pressure is lower (communicating tubes) and the flow of acid is slower than if the liquid level of the acid is higher.
By means of a flow resistance that occurs, for example, due to correspondingly thin connecting channels.
By means of a body that absorbs the acid and slowly releases it. This body can be situated in a reservoir. By means of a body with a high diffusion resistance, for example a body that enables absorption due to its porosity. The absorption due to capillary forces of the body, however, is less than the acid affinity of the electrode/electrolyte system. Such a body should be situated in the region up-stream of the MEA or in the reservoir. The body can, for example, divide the supply channel spatially from the MEA. The body can be situated in the supply channel or in the acid reservoir. The body can also be situated in the supply system (distributor channel, connecting channel, reservoir).

A body or supply element or also the transport aid can be a membrane element, a wick, a woven cloth, a net, one or more fibers, a fleece, or capillaries between polymer films.

The supply element can be situated between the polymer membrane and the gas diffusion electrode or also in a region adjoining one of the two.

Furthermore, a rapid supply of acid can also be advantageous. For example, the flow of acid from the supply channel into the feed channels (when the fuel cell is at a standstill) can be taken into account or can be intentional; within a few hours, for example, the acid is absorbed into the GDE and can spread throughout the electrode layer and/or the membrane.

The invention will be explained in greater detail below based on the drawings. In the drawings:

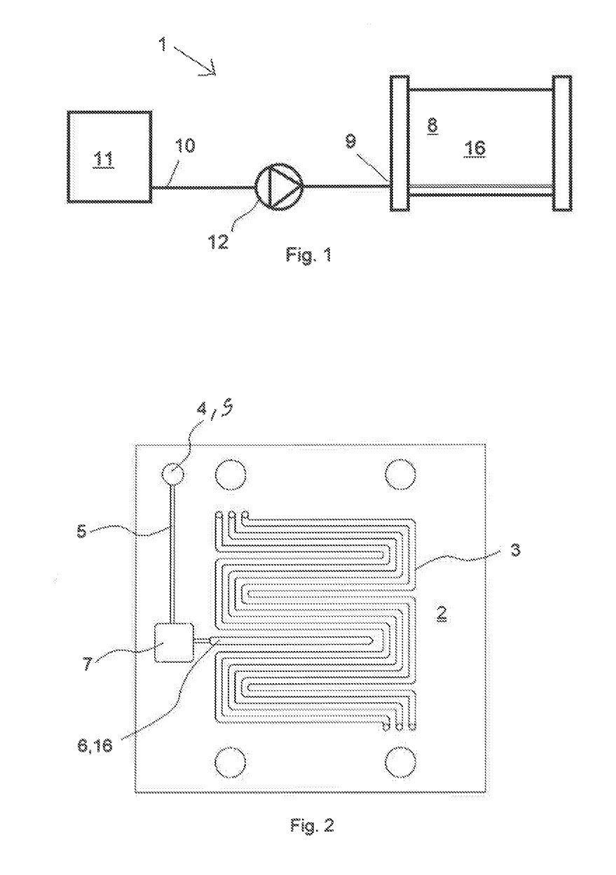

FIG. 1 is a schematic depiction of a device according to the invention, having a fuel cell stack with an acid reservoir, a storage tank, a line section, and supply device,

FIG. 2 is a schematically depicted top view of a supply plate with an acid reservoir of a device according to the invention,

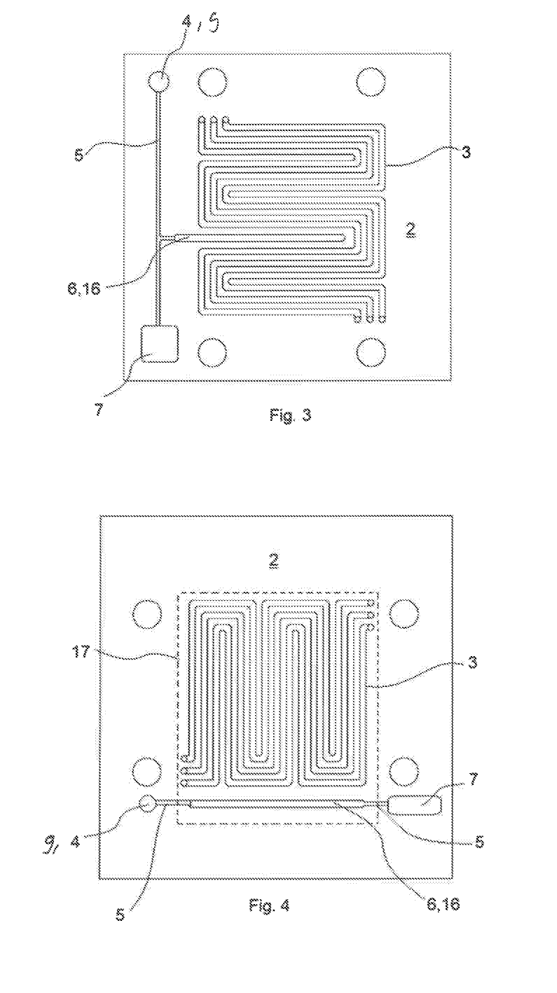

FIG. 3 is a schematically depicted top view of another embodiment of a supply plate with an acid reservoir of a device according to the invention,

FIG. 4 is a schematically depicted top view of another embodiment of a supply plate with an acid reservoir of a device according to the invention,

FIG. 5 is a schematically depicted top view of another embodiment of a supply plate with a gas diffusion electrode, a polymer film, a sealing frame, and an acid reservoir of a device according to the invention,

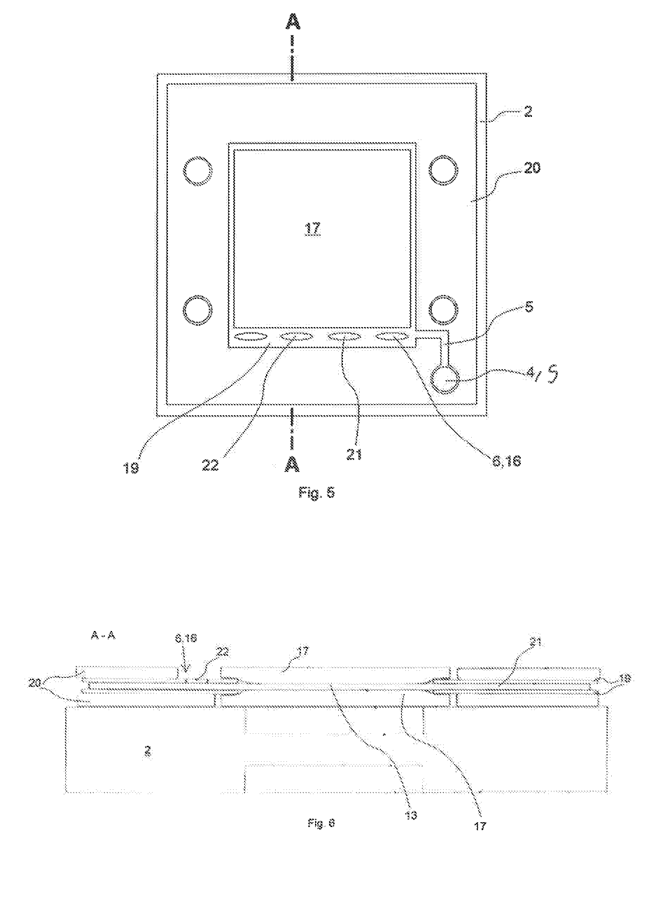

FIG. 6 shows the embodiment from FIG. 5 in a view cut laterally along the line A-A,

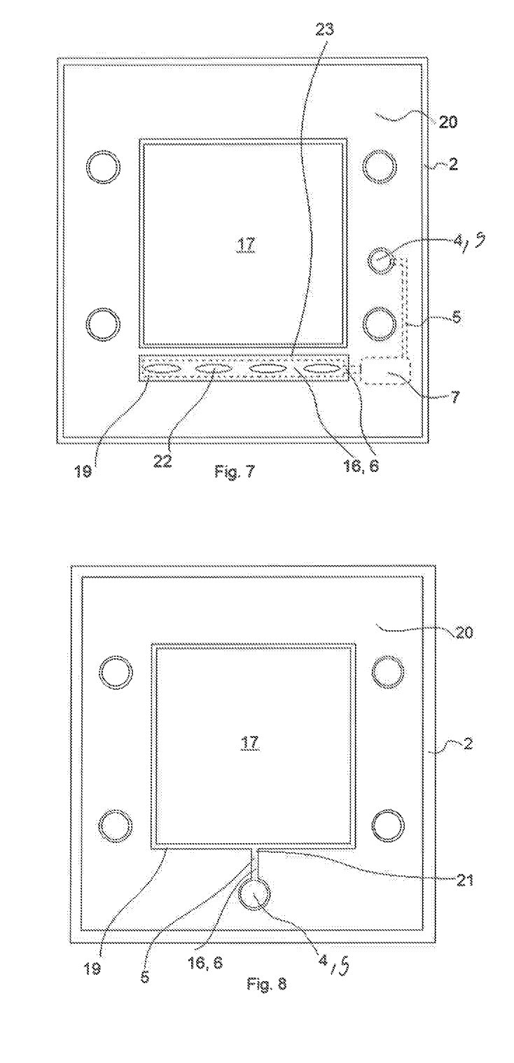

FIG. 7 is a schematically depicted top view of another embodiment of the embodiment shown in FIG. 5,

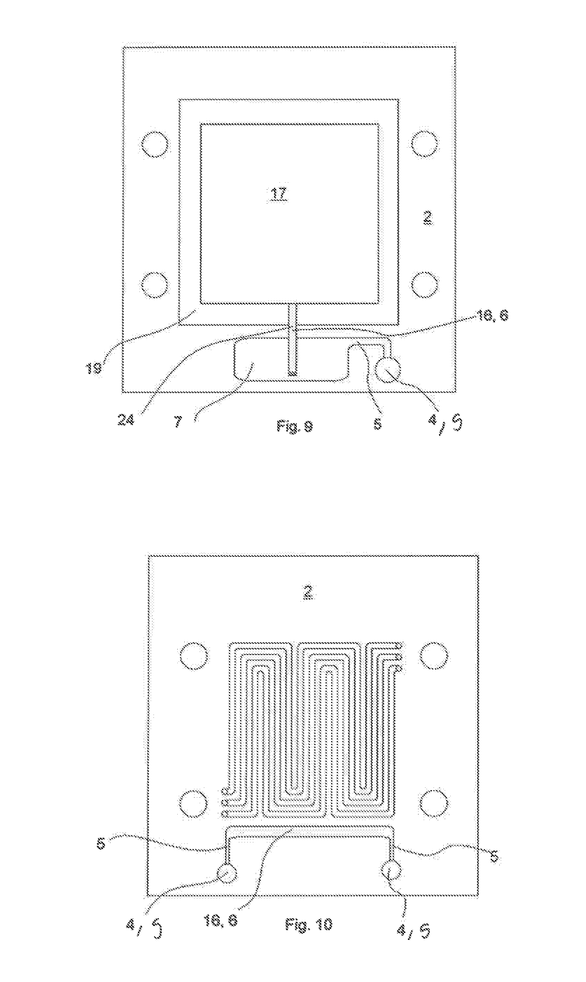

FIG. 8 is a schematically depicted top view of another embodiment of a supply plate with a polymer membrane, a gas diffusion electrode, a sealing frame, and an acid reservoir of a device according to the invention,

FIG. 9 is a schematically depicted top view of another embodiment of a supply plate of a device according to the invention,

FIG. 10 is a schematically depicted top view of an alternative embodiment of a supply plate with an acid reservoir,

FIG. 11 is a schematically depicted top view of an alternative embodiment of a supply plate with an acid reservoir,

FIG. 12 is a schematic, laterally sectioned detail view of a cell of a fuel cell stack according to another embodiment,

FIG. 13 is a schematic, laterally sectioned detail view of a cell of a fuel cell stack according to another embodiment, and

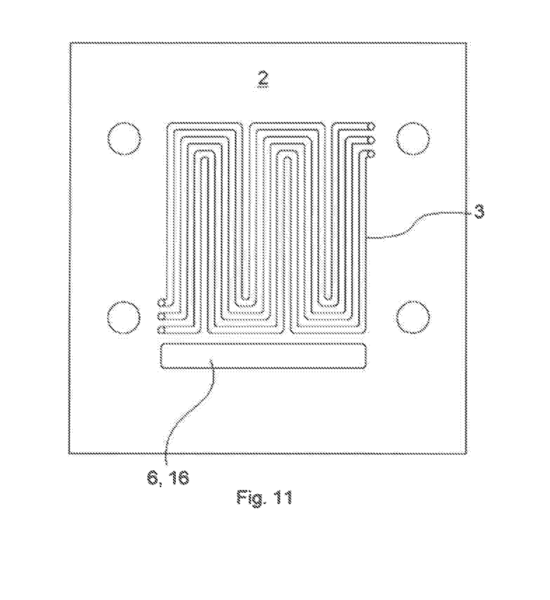

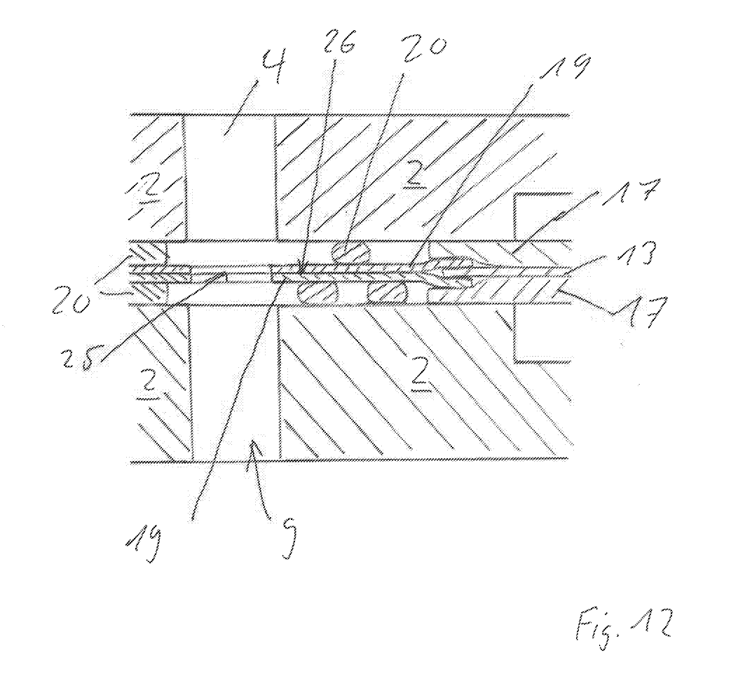

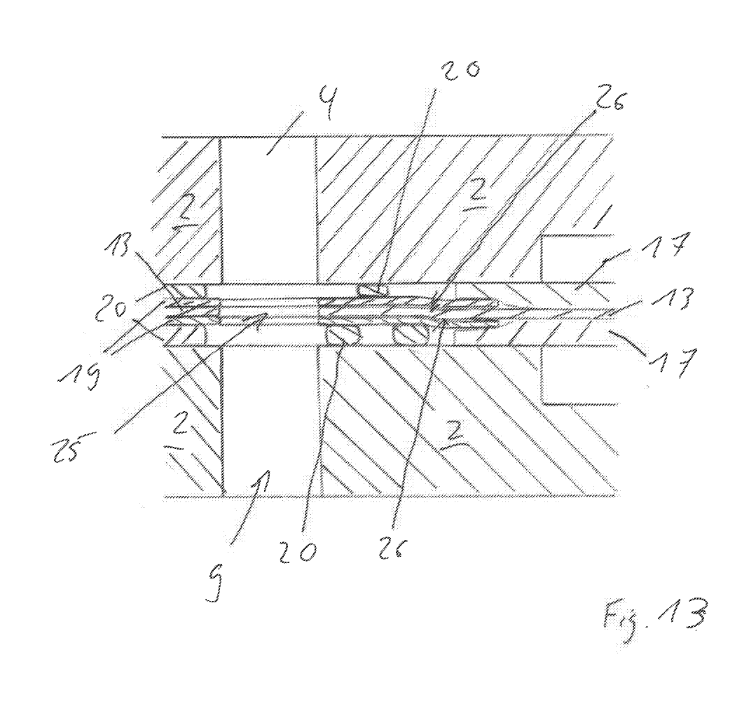

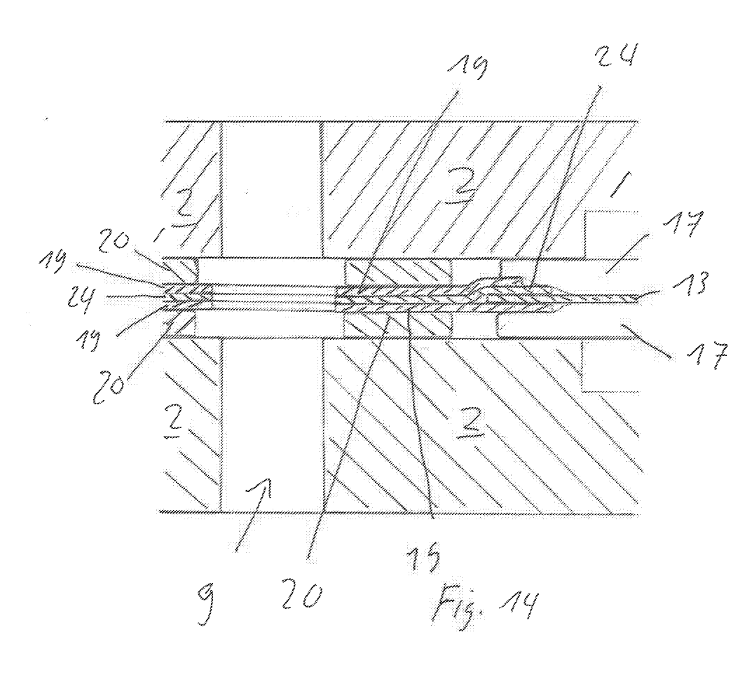

FIG. 14 is a schematic, laterally sectioned detail view of a cell of a fuel cell stack according to another embodiment.

A device 1 according to the invention for extending the service life of an HT-PEM fuel cell includes a HT-PEM fuel cell and an acid reservoir. The fuel cell 8 is preferably a fuel cell stack composed of a plurality of cells (FIG. 1).

The individual cells of the fuel cell stack 8 include a supply plate 2 with an anode channel structure 3, an anode gas diffusion electrode 17, an electrolyte-containing polymer membrane 13, a cathode gas diffusion electrode 17, and a supply plate 2 with a cathode channel structure 3.

The supply plates 2 are embodied in accordance with the supply plates 2 according to the invention described below.

In the fuel cell stack, distributor channel sections 4 of the supply plates 2 form a distributor channel 9 that is composed of the individual distributor channel sections 4 and is fluid-tight and gas-tight in relation to the outside (FIGS. 2 through 4).

The distributor channel 9 is connected to a storage tank 11 via a line section 10.

A supply device 12 such as a pump is integrated into the line section 10 and is embodied to pump acid from the storage tank 11 into the distributor channel 9.

The line section 10, the supply device 12, and the storage tank constitute a supply system 18.

A control unit (not shown) is provided to control the supply or metering of acid into the fuel cell stack.

A first embodiment of a supply plate 2 according to the invention is described below, which has a channel structure 3 and an acid supply reservoir 16 (FIG. 2).

The channel structure 3 can be an anode channel structure or a cathode channel structure.

The supply plate is embodied in a plate shape with two surface sides and four end faces and is composed of an electrically conductive material such as graphite or a graphite-containing material.

It can also be composed of a suitable metallic material. Furthermore, the channel structure 3 can be embodied on only one surface side or on both sides of the supply plate.

The channel structure 3 is open toward a surface side and for example extends in a meandering form.

In at least one corner of the supply plate 2, a distributor channel section 4 is provided, which is embodied in the form of a through bore.

The distributor channel section 4 is situated perpendicular to the plane in which the channel structure 3 is embodied.

The distributor channel section 4 is connected to a reservoir 7 for accommodating acid via a connecting channel 5, which extends in the same plane as the channel structure 3 and is likewise embodied as open toward a surface side.

For example, the reservoir 7 is a hemispherical or rectangular opening or a broader and/or expanded channel that is open toward the surface side.

Branching off from the reservoir 7 there is a supply channel 6, which extends approximately into the middle of the region of the channel structure 3 and is likewise embodied as open toward a surface side.

According to this embodiment, the supply channel 6 is the acid supply reservoir 16 via which a replenishing flow of acid is fed into a cell of a fuel cell stack 8. The replenishing occurs because the acid in the supply channel is in direct contact with the gas diffusion substrate.

A second embodiment of a supply plate 2 according to the invention, which has a channel structure 3 and an acid supply reservoir 16, is described below (FIG. 3). Provided that nothing to the contrary is described here, this supply plate has the same features as the above-described supply plate according to the first embodiment.

According to the second embodiment, the reservoir 7 is situated to the side of the supply plate and is likewise connected to the connecting channel 5.

The supply channel 6, which once again constitutes the acid supply reservoir 16, branches off at approximately half the length of the connecting channel 5 in the region of the channel structure 3 and extends into the latter.

A third embodiment of a supply plate 2 according to the invention will be described below, which has a channel structure 3 and an acid supply reservoir 16 (FIG. 4). Provided that nothing to the contrary is described here, this supply plate has the same features as the supply plate 2 according to the second embodiment.

Fuel cell stacks built into a system always have a support side A, which is oriented toward the surface of the earth. According to this embodiment, the support side is the lower end face shown in FIG. 4, i.e. the support side extends orthogonal to the plane in which the supply plates lie.

In the context of the present invention, it is also possible for the support side to extend parallel to the plane in which the supply plates lie.

The dashed line in FIG. 4 indicates the support region of a gas diffusion electrode 17.

The connecting channel 5 has two sections. The supply channel 6 or acid supply reservoir 16 extends between these two sections.

By contrast with the two above-described exemplary embodiments of the supply plate, the sections of the connecting channel 5 extend into the region in which the gas diffusion substrate 17 is supported.

Such an arrangement of the supply channel 6 prevents acid from traveling into the channel structure 3 of the supply plate 2 due to the force of gravity.

A fourth embodiment of a supply plate 2 will be described below, which has a gas diffusion electrode 17, a polymer film (subgasket) 19, a sealing frame 20, and an acid supply reservoir 16 (FIG. 5 and FIG. 6). Provided that nothing to the contrary is described here, this supply plate has the same features as the supply plates described above.

According to this embodiment, the polymer membrane 13 does not end approximately flush with the edge region of the gas diffusion electrode 17, but instead has an edge section 21 that protrudes from the circumference of the region of the gas diffusion electrode 17.

At the top and bottom, this edge section 21 of the polymer membrane 13 is covered by the frame-shaped reinforcing frame 19 (polymer film). The polymer film 19 has a thickness of approximately 25 μm.

A sealing frame 20 is respectively provided against the polymer film 19 and the supply plate 2.

The supply plate 2 has a distributor channel section 4, which is connected to the acid supply reservoir 16 via a connecting channel 5.

The connecting channel 5 is embodied as an opening in the sealing frame 20.

The acid supply reservoir 16 is delimited at the top by the supply plate 2, at the side by the sealing frame 20, and at the bottom by the reinforcing frame 19—which is provided with openings 22—and the edge section 21 of the polymer membrane 13.

The openings 22 of the reinforcing frame 19 permit acid to pass through from the acid supply reservoir 16 into the edge section 21 of the polymer membrane 13. In this way, acid can travel from the acid supply reservoir 16 into the polymer membrane 13 and from there into the gas diffusion electrode 17.

The fact that several, for example four, small openings 22 are provided prevents a swelling of the membrane over a large area, which can lead to cracks and detachment.

An acid supply reservoir of this kind is preferably situated parallel to the support surface of the fuel cell stack in order to prevent the acid from draining into the channel structure of the supply plate.

The acid can thus travel on the one hand into the polymer membrane and on the other hand, also into a boundary layer that is formed between the polymer film 19 or subgasket and the polymer membrane, this flow being produced by capillary forces.

In addition, the polymer film serves to reinforce the membrane in the edge region.

A fifth embodiment of a supply plate 2 according to the invention is described below (FIG. 7). Provided that nothing to the contrary is described here, this has the same features as the embodiment shown in FIG. 5.

According to this embodiment, the sealing frame 20 has a partition 23 that also delimits the acid reservoir 16. This partition 23—which extends approximately parallel to a support surface, from one side of the sealing frame 20 to a side opposite from this side—should, by means of the pressure emanating from the sealing frame, prevent a swelling of the membrane and an unwanted flow of acid into the feed channels.

Also according to this embodiment, a reservoir 7 is provided; the dashed lines indicate corresponding openings in a supply plate (not shown) that rests on top of the sealing frame. The reservoir 7 is integrated into the connecting channel 5.

Another embodiment of a supply plate 2 is described below (FIG. 8), which, provided that nothing to the contrary is described here, has the same features as the supply plates 2 described above.

According to this embodiment, a distributor channel section 4 is embodied in the supply plate 2.

The sealing frame 20 has an opening embodied in the form of a connecting channel 5. According to this embodiment, the opening 22, the connecting channel 5, or the supply channel 6 constitutes the acid supply reservoir 16 since the opening is delimited by the polymer film 19 and consequently, acid contained in the acid supply reservoir 16 is in direct contact with the edge section 21 of the polymer film 19 and thus the polymer membrane 13. Furthermore, the acid is additionally or alternatively directly in contact with the gas diffusion electrode 17.

Another embodiment of a supply plate is described below (FIG. 9). Provided that nothing to the contrary is described here, this supply plate has the same features as the supply plates described above.

In the supply plate 2, a distributor channel section 4 is provided, which feeds via a connecting channel 5 into a reservoir 7 likewise embodied as a cavity in the supply plate. A supply channel 6 constitutes an opening from the reservoir 7 or a passage from the reservoir 7 to the gas diffusion electrode 17 and to the polymer membrane 13.

The region of the supply channel 6 situated in the edge section 21 of the polymer film 19 constitutes the acid supply reservoir 16.

A glass fiber wick 24 extends from the gas diffusion electrode 17 through the section of the connecting channel 5 into the reservoir 7, which according to this embodiment, is a component of the acid supply reservoir 16.

Acid that has been brought into the reservoir 7 can thus be drawn by capillary forces through the wick 24, which is for example a glass fiber wick, into the electrode layer of the gas diffusion electrode and/or into the membrane.

According to an alternative embodiment of a supply plate 2 (FIG. 10) that is described below, the supply plate 2 has two distributor channel sections 4.

These distributor channel sections 4 are each connected to a supply channel 6 via a respective connecting channel 5.

According to this embodiment, a circulating device (not shown) such as a pump is provided; one distributor channel section 4 is embodied as a supply distributor channel so that acid travels into the supply distributor channel by means of the circulating device and the other distributor channel section 4 is correspondingly embodied as a draining distributor channel via which the acid is drained.

According to this embodiment, the acid is not only supplied and replenished but also circulates in the fuel cell stack via distributor channels 9, which are embodied by the distributor channel sections 4.

The acid in the supply channel 6 that constitutes the acid supply reservoir once again directly contacts the gas diffusion electrode 17 and/or the polymer membrane 13.

Other embodiments of the present invention with subgaskets 19 are described below, which, provided that nothing to the contrary is described here, correspond to the embodiments with subgaskets 19 described above (FIGS. 12 through 14).

According to one of these embodiments, the acid is supplied to the cells via the distributor channel sections 4 and/or the distributor channel 9.

According to one embodiment, a subgasket 19 (polymer film; reinforcing frame) extends into the distributor channel 4 respectively above and below the polymer membrane 13.

In the region of the distributor channel 9, a corresponding opening 25, i.e. a hole, is provided in the subgaskets 19, in order not to hinder the flow of acid through the distributor channel 9.

In the boundary layers in which the subgaskets 19 contact each other, capillaries 26 are provided via which the acid travels into the reactive region of the gas diffusion electrodes 17 and/or the polymer membrane 13 of a cell.

These capillaries 26 are a transport aid as defined by the present invention.

According to another embodiment, the membrane 13 and at least one subgasket 19 can also extend into the distributor channel 9 (FIG. 13).

In the region of the distributor channel 9, a corresponding opening 25, i.e. a hole, is once again embodied in the subgasket and the membrane.

In the boundary layers in which the subgasket 19 and membrane 13 contact each other, capillaries 26 are provided via which the acid travels into the reactive region of the gas diffusion electrodes 17 and/or the polymer membrane 13 of a cell.

According to this embodiment, a subgasket 19 respectively situated above and below the polymer membrane 13—and the membrane 13 itself—can extend into the distributor channel 9. Then corresponding capillaries 26 are provided above and below the membrane 13, between the membrane 13 and subgasket 19.

In order to facilitate the introduction of the acid, according to another embodiment, a transport aid such as a net, a fleece, a wick, or a similar distributor structure can be provided between the boundary layers, FIG. 14.

Various embodiments of a method according to the invention for extending the service life of high-temperature polymer electrolyte membrane fuel cells are described below.

In the following, a distinction is drawn between an active replenishment of acid and a passive replenishment of acid.

With an active replenishment of acid, the pump 12 pumps acid from the storage tank 11, via the line section 10, into the distributor channel, and from there into the reservoir 7.

This is carried out until the reservoir 7 is completely filled with acid. Then the acid flows from the reservoir 7 into the supply channel 6. This has the advantage that a uniform phosphoric acid distribution takes place independent of the position of the individual cells since first, the reservoirs 7 with the same respective volume in the supply plates are completely filled and after they have been filled, the largest part of the acid supply into the membrane takes place.

From the supply channel 6 or the acid supply reservoir, the acid then flows slowly and in particular mainly only in the region in which the gas diffusion substrate contacts the supply channel via the gas diffusion substrate—also in a locally restricted fashion—into the gas diffusion electrode and from there into the electrolyte-containing polymer membrane 13 in order to replace the expended electrolyte there (phosphoric acid, sulfuric acid). From the electrolyte-containing polymer membrane 13 and/or the electrode layer, the acid is then distributed in planar fashion across the active surface of the cell and then partially released to the opposite electrode layer.

All of the reservoirs 7 in the supply plates 2 have the same volume. A special case exists when individual cells have different operating temperatures. Then it is also possible to provide reservoirs with different volumes in order to be able compensate for the different acid consumption. The reservoirs 7 serve to homogenize the supply of acid to each individual cell of the fuel cell stack. In this way, each membrane electrode assembly (MEA), which is composed of the electrolyte-containing polymer membrane and the gas diffusion electrodes with the catalyst applied to the gas diffusion substrate, receives the same quantity of acid.

With a passive supply of acid, it is possible to eliminate the supply device 12.

With a supply of this kind, a replenishing flow of acid from the storage tank outside the fuel cell stack is automatically supplied to the fuel cell stack, for example due to a volume increase of the acid due to water absorption from the cell. This makes it possible to provide a continuous supply.

According to an embodiment of this kind, the reservoir 7 can also serve as a storage tank 11, making it possible to eliminate the storage tank and other external devices entirely.

According to another embodiment of this kind, it is also possible to eliminate the distributor channel 9 and supply channel 6. The acid then travels directly from the reservoir 7 embodied as a storage tank via the gas diffusion layer or the gas diffusion substrate into the electrode layer and from there, into the electrolyte-containing polymer membrane, in order to replace the electrolyte that has been removed from the fuel cell.

Consequently, the reservoir 7 is embodied as an independently delimited space in the supply plate 2 and/or in the sealing frame 20 (FIG. 11). With an embodiment in the sealing frame, an acid reservoir of this kind can also be considered to be a closed distributor channel section 5. An embodiment of this kind with an independent reservoir 7 constitutes a separate concept of the invention.

According to the invention, therefore, the acid can be either actively pumped to the gas diffusion electrode or passively transported by gravity, by volume increase, by adhesion forces or capillary forces, or by volume increase due to water absorption of the acid solution because of its hygroscopic properties. The water absorption from the product water of the fuel cell is accompanied by a volume increase, which promotes an introduction by the force of pressure.

According to the invention, the acid from an acid reservoir—or from a chamber that is embodied in the supply plate and filled with acid—travels through the hydrophobic gas diffusion substrate and through the gas diffusion layer, into the electrode layer and from there, travels into the electrolyte membrane due to the high acid affinity or hydrophilicity of the membrane.

The affinity of the electrolyte is based not only on its absorptive capacity and the water that it contains, but also on the basic groups of the electrolyte, which absorb hydrogen ions, for example, and attract the acid anion by means of the resulting positive charge. Consequently the channel empties and can be refilled again continuously or discontinuously.

In order to reduce the viscosity or the surface tension of the acid or to embody the surface of the gas diffusion electrode to be more absorptive, additives such as alcohols can be provided or diluted acid can be used. This facilitates a penetration of acid into the porous structure of the gas diffusion electrode. Since the contact of concentrated acid with the PBI membrane can cause a swelling of the polymer membrane to occur due to locally excessive acid absorption in the polymer matrix and this can lead to irregular current density distribution in the operation of the fuel cell and to membrane damage, the acid can be diluted with a high-boiling solvent (e.g. ethylene glycol).

According to another embodiment, the acid can also be supplied directly to the polymer membrane. In this case, the acid travels from a reservoir and into the membrane via a supply element such as an edge section 21 that is embodied on the membrane or integrally formed onto it, a membrane strip, a tab, or a separate component such as a membrane section or wick. A variety of designs are possible for contacting the acid with the membrane. They will be explained briefly below.

In order to enable a better or faster distribution of acid directly onto the membrane, a wick, a net arranged in planar fashion, or fibers with a suitable orientation can be positioned between the electrode and membrane as a transport aid for the acid. The fibers are made in such a way that they conduct acid and if possible, absorb enough acid that they do not hinder the proton conduction of the combination of electrolyte membrane and transport aid. These transport aids can also be embodied so that they contact the acid reservoir or the reservoir.

A supply to the region of the polymer membrane can also be provided, said supply being embodied, for example, in a supply plate and the acid traveling directly to the membrane via holes in the gas diffusion electrode.

The supply of acid to the region of the polymer membrane can also take place by means of polymer films (“subgaskets”), which are situated at the edge of the cell surface and contact the membrane or rest on it, via the cavity situated between two or more polymer films or between a polymer film and the membrane, taking advantage of capillary forces.

In order to avoid an outflow of acid, for example from a supply channel through the gas diffusion layer into adjacent feed channels, a complete or partial sealing or compression of parts of the gas diffusion layer can be provided. The gas diffusion layer can, for example, be sealed by bonding cavities with a cross-linking polymer or by filling them with PTFE particles. A partition in the supply plate or a polymer seal allows additional pressure to be selectively applied to the gas diffusion layer, which compresses the gas diffusion layer and reduces the porosity in this region.

A positioning of the supply channel in the lower regions of the supply plate is advantageous for avoiding the outflow of acid from the supply channel into underlying feed channels due to the force of gravity.

The outflow of acid for example from the supply channel into adjacent feed channels, however, can also be used for a more extensive distribution of acid over the electrode surface. In this case, among other things, acid passes from the feed channels into the gas diffusion electrode or the polymer membrane.

A supply of phosphoric acid can take place both as the fuel cell is being fed with reactands and without a feeding, both with a current flow and without a current flow, as well as both with and without tempering.

Instead of phosphoric acid, it is also possible to use a different electrolyte such as sulfuric acid or an electrolyte-containing mixture (e.g. phosphoric acid with ethylene glycol and ionic liquids) and for a polymer membrane, it is possible to use a suitable HT-PEM membrane such as cross-linked AB-PBI, para-PBI, or an aromatic polyether. The electrolyte can also contain additives (e.g. salts, tensides, PBI).

### REFERENCE NUMERAL LIST

1 device
2 supply plate
3 channel structure
4 distributor channel section
5 connecting channel
6 supply channel
7 reservoir
8 fuel cell/fuel cell stack
9 distributor channel
10 line section
11 storage tank
12 supply device
13 electrolyte-containing polymer membrane
14 tab
15 end section
16 acid reservoir
17 gas diffusion electrode
18 supply system
19 polymer film
20 sealing frame
21 edge section
22 openings
23 partition
24 wick
25 opening
26 capillary

1. A device for extending the service life of an HT-PEM fuel cell with an HT-PEM fuel cell stack, where one cell of the stack is constructed according to the following sequence:
a supply plate with an anode channel structure,
an anode gas diffusion electrode,
an electrolyte-containing polymer membrane,
a cathode gas diffusion electrode,
a supply plate with a cathode channel structure,
wherein
at least one acid-filled acid reservoir is provided, which is connected to a distributor channel extending in the supply plates approximately perpendicular to the channel structures, the distributor channel being connected to at least one of the gas diffusion electrodes and/or the polymer membrane of at least one of the cells of the fuel cell stack in such a way that acid can be supplied to at least one of the gas diffusion electrodes and/or the polymer membrane of at least one of the cells of the fuel cell stack.

2-16. (canceled)

17. The device according to claim 1,
wherein
the acid reservoir contains phosphoric acid, sulfuric acid, or another electrolyte or electrolyte-containing mixture.

18. The device according to claim 17,
wherein
the distributor channel is connected to at least one of the gas diffusion electrodes and/or the polymer membrane of at least one of the cells of the fuel cell stack via a connecting means such as capillaries, a supply channel, a supply element, a transport aid, a reservoir, or a channel-like structure.

19. The device according to claim 18,
wherein
branching off from the distributor channel is a connecting channel, which is embodied in the plane of the channel structure and is connected to a supply channel lying in the same plane, which supply channel is embodied as an acid supply reservoir, and acid can be supplied to the fuel cell via these channels.

20. The device according to claim 1,
wherein
the distributor channel is connected to at least one of the gas diffusion electrodes and/or the polymer membrane of at least one of the cells of the fuel cell stack via a connecting means such as capillaries, a supply channel, a supply element, a transport aid, a reservoir, or a channel-like structure.

21. The device according to claim 1,
wherein
branching off from the distributor channel is a connecting channel, which is embodied in the plane of the channel structure and is connected to a supply channel lying in the same plane, which supply channel is embodied as an acid supply reservoir, and acid can be supplied to the fuel cell via these channels.

22. The device according to claim 21,
wherein
a reservoir is integrated into the connecting channel and/or the supply channel.

23. The device according to claim 22,
wherein
the distributor channel is composed of distributor channel sections of each cell and the distributor channel is connected to the acid reservoir.

24. The device according to claim 23,
wherein
a supply device is provided for supplying acid from an external storage tank, which constitutes the acid reservoir, into the distributor channel.

25. The device according to claim 24,
wherein
in the fuel cell stack, distributor channel sections for supplying and draining acid are embodied in such a way that it is possible to circulate acid through the fuel cell by means of a circulating device.

26. The device according to claim 25,
wherein
the supply device and/or the circulating device can be triggered by a control unit in such a way that a controlled supply of acid into the cells of the fuel cell stack takes place.

27. The device according to claim 26,
wherein
the supply element is connected to the acid reservoir and the electrolyte-containing polymer membrane and/or the gas diffusion electrode in such a way that acid from the acid reservoir can be supplied to the polymer membrane and/or the gas diffusion electrode, the supply element being situated between the polymer membrane and gas diffusion electrode or also in a region adjacent to the two.

28. The device according to claim 27,
wherein
the supply element is situated in the acid supply reservoir and/or in the supply channel.

29. The device according to claim 1
wherein
the distributor channel is composed of distributor channel sections of each cell and the distributor channel is connected to the acid reservoir.

30. The device according to claim 1,
wherein
a supply device is provided for supplying acid from an external storage tank, which constitutes the acid reservoir, into the distributor channel.

31. The device according to claim 1,
wherein
in the fuel cell stack, distributor channel sections for supplying and draining acid are embodied in such a way that it is possible to circulate acid through the fuel cell by means of a circulating device.

32. The device according to claim 1,
wherein
the supply device and/or the circulating device can be triggered by a control unit in such a way that a controlled supply of acid into the cells of the fuel cell stack takes place.

33. The device according to claim 1,
wherein
the supply element is connected to the acid reservoir and the electrolyte-containing polymer membrane and/or the gas diffusion electrode in such a way that acid from the acid reservoir can be supplied to the polymer membrane and/or the gas diffusion electrode, the supply element being situated between the polymer membrane and gas diffusion electrode or also in a region adjacent to the two.

34. The device according to claim 33,
wherein
the supply element is embodied in the form of a wick or a net or of fibers, as capillaries between polymer film(s) and/or the membrane, or as an absorbent body, e.g. with a high diffusion resistance and a suitable porosity so that the acid can be released from the body slowly.

35. The device according to claim 1,
wherein
the supply element is situated in the acid supply reservoir and/or in the supply channel.

36. The device according to claim 1,
wherein
the distributor channel section is embodied as an independently delimited space in the supply plate and defines an acid reservoir.

37. A method for extending the service life of high-temperature polymer electrolyte membrane fuel cells, in which acid is supplied from an acid-filled acid reservoir, via a distributor channel extending approximately perpendicular to the channel structures of a supply plate, to one of the gas diffusion electrodes and/or a polymer membrane of at least one cell of a fuel cell stack.

38. The method according to claim 1,
wherein
the supply is carried out in such a way that the acid travels into the electrode layer of a gas diffusion electrode and from there into the polymer matrix of the polymer membrane, the acid is distributed in planar fashion across the electrode layer and/or the membrane and/or its boundary layer, and a part of it is released to the opposite GDE.

39. The method according to claim 35,
wherein
the supply is carried out in such a way that the acid travels into the electrode layer of a gas diffusion electrode and from there into the polymer matrix of the polymer membrane, the acid is distributed in planar fashion across the electrode layer and/or the membrane and/or its boundary layer, and a part of it is released to the opposite GDE.

40. The method according to claim 1,
wherein
the supply takes place by means of gravity in such a way that the acid is supplied slowly, with the entry of acid into the feed channels being hindered by the fact that the reservoir is situated beneath or at the same height as the supply channel and thus the force acting on the acid is lower and the flow of acid is slower.

41. The method according to claim 36,
wherein
the supply takes place by means of gravity in such a way that the acid is supplied slowly, with the entry of acid into the feed channels being hindered by the fact that the reservoir is situated beneath or at the same height as the supply channel and thus the force acting on the acid is lower and the flow of acid is slower.
